(19) United States
(12) Patent Application Publication
(10) Pub. No.: US 2025/0246171 A1
(43) Pub. Date: Jul. 31, 2025

(54) MULTIMODAL DIGITAL AUDIO GENERATION

(71) Applicant: Adobe Inc., San Jose, CA (US)

(72) Inventors: Sanjoy Chowdhury, College Park, MD (US); Sayan Nag, Toronto (CA); Joseph Koonthanam Jose, Kottayam (IN); Balaji Vasan Srinivasan, Bangalore (IN)

(73) Assignee: Adobe Inc., San Jose, CA (US)

(21) Appl. No.: 18/425,272

(22) Filed: Jan. 29, 2024

(51) Int. Cl. G10H 1/00; G06F 40/40; G06V 10/40; G06V 10/774; G06V 10/80

(52) U.S. Cl. CPC G10H 1/0025; G06F 40/40; G06V 10/40; G06V 10/774; G06V 10/806; G10H 2210/111; G10H 2220/101; G10H 2220/441

(57) ABSTRACT

Multimodal digital audio generation techniques are described that leverage multimodal inputs such as a digital image and text to generate digital audio using machine learning. In one or more examples, a digital image and text are received. Image semantic information is extracted from the digital image using machine learning. Digital audio is generated using generative machine learning based on the text and the image semantic information. The digital audio is then rendered and output by a digital audio output device.

### BACKGROUND

Digital audio generation, as implemented using machine learning, encounters numerous technical challenges involving incorporation of a structure and context using sounds for use in a desired scenario. These challenges are further exacerbated when confronted with types of digital audio having increasing levels of complexity, an example of which is digital music.

Generation of digital audio as implemented in conventional approaches lacks an ability to address context (e.g., emotional and/or cultural context) in a manner that maintains thematic and structural integrity of the digital audio. However, digital music is deeply tied to emotions and cultural contexts to maintain thematic and structural integrity. Consequently, lack of an ability by conventional digital audio generation techniques to address context causes these techniques to be ill suited for digital music scenarios.

### SUMMARY

Multimodal digital audio generation techniques are described that leverage multimodal inputs to generate digital audio (e.g., digital music) using machine learning. In one or more examples, a digital image and text are received as examples of multimodal inputs. Image semantic information is extracted from the digital image using machine learning, e.g., by a first diffusion model. Digital audio is generated using generative machine learning (e.g., by a second diffusion model) based on the text and the image semantic information extracted from the digital image. The digital audio is then rendered and output by a digital audio output device.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ multimodal digital audio generation techniques described herein.

FIG. 2 depicts an implementation example of operation of a generative machine-learning system of FIG. 1 in greater detail as employing an image generative machine-learning system and an audio generative machine-learning system to generate digital audio.

FIG. 3 depicts a system in an example implementation showing operation of an image generative machine-learning system of FIG. 2 in greater detail.

FIG. 4 depicts a system showing operation of an audio generative machine-learning system of FIG. 2 in greater detail as generating digital audio based on text and image semantic information detected from the image generative machine-learning system of FIG. 3.

FIG. 5 depicts a system in an example implementation showing training of the generative machine-learning system of FIGS. 2-4 in greater detail.

FIG. 6 depicts a system in an example implementation showing operation of a decoder layer of a text-to-music diffusion model of FIG. 5 in greater detail.

FIG. 7 depicts an example implementation of generation of training data usable to train the generative machine-learning system of FIG. 1.

FIG. 8 is a flow diagram depicting an algorithm as a step-by-step procedure in an example implementation of operations performable for accomplishing a result of generating digital audio based on multimodal inputs.

FIG. 9 depicts an algorithm describing training of a generative machine-learning system of FIG. 5.

FIG. 10 depicts an algorithm describing use of a trained generative machine-learning system of FIG. 5.

FIG. 11 illustrates an example system including various components of an example device that can be implemented as any type of computing device as described and/or utilize with reference to the previous figures to implement embodiments of the techniques described herein.

### DETAILED DESCRIPTION

### Overview

Digital audio generation through use of machine learning involves technical complexities and challenges that are not found in other types of artificial intelligence and machine learning techniques. Generation of digital audio, for instance, as implemented in conventional approaches lacks an ability to address context (e.g., emotional and/or cultural context) in a manner that maintains thematic and structural integrity of the digital audio. As a result, conventional techniques are limited to scenarios having limited complexity, such as for use in generating ambient sounds. Therefore, conventional techniques are ill suited for complex scenarios such as those involved in generating digital music. Consequently, the inability of conventional techniques to address context while maintaining thematic and structural integrity limits applicability of the conventional techniques to use in simple scenarios.

Accordingly, digital audio generation techniques are described that support multimodal operation to generate digital audio using machine learning based on multimodal inputs, e.g., text and digital images. As a result, the multimodal inputs are usable as part of machine learning to capture and express context to incorporate emotions and cultural nuances that are present in complex forms of digital audio, such as digital music, while maintaining integrity of the digital audio, which is not possible in conventional techniques.

In one or more examples, a generative machine-learning system is configured to generate digital audio (e.g., digital music) from multimodal inputs. Text, for instance, may be entered via a user interface, such as “a soft musical track of folk acoustic genre played on a violin.” A digital image is also received that is selected by a user, such as a digital image of “starry night” of the painting by Vincent Van Gogh. Other examples are also contemplated, e.g., use of a machine-learning model configured as a caption generator to generate the text as a caption based on the digital image, automatically and without user intervention.

The generative machine-learning system then generates waveform data (e.g., a music waveform) in this example which is conditioned on the digital image and given textual instructions. To do so, the generative machine-learning system employs an image generative machine-learning system and an audio generative machine-learning system. The image and audio generative machine-learning systems, in one or more instances, are each implemented using a respective diffusion model, e.g., latent diffusion models (LDMs). Diffusion models are a class of generative models that are trained by transforming a sample of noise (e.g., random noise) into a structured output over successive iterations. Latent diffusion models apply the diffusion process in a latent space (e.g., to a compressed or abstract representation of the data) which increases operational efficiency during both training and subsequent use of the trained model through use of lower-dimensional data.

The image generative machine-learning system is configured to extract relevant visual information from the digital image, which is referred to as image semantic information. To do so, the image generative machine-learning system is implemented to form a generative digital image from a noisy digital image, e.g., which is a corrupted version of a digital image received as an input. The image generative machine-learning system is configured to learn image semantic information as part of constructing the digital image from the noisy digital image. A visual synapse module is then employed to introduce the image semantic information learned from constructing the generative digital image to respective layers of the audio generative machine-learning system, e.g., a text-to-music generative model. The text-to-music generative model, as a diffusion model, is configured to generate the digital audio (e.g., digital music) based on the image semantic information from the digital image and the text.

Image semantic information from the image generative machine-learning system, for example, is instilled into the text-to-music diffusion model of the audio generative machine-learning system using a pre-trained and “frozen” text-to-image diffusion model. To do so, a noisy digital image is generated from the digital image, e.g., inverted to form a noisy latent digital image. Image semantic information configured as self-attention features from decoder layers of a text-to-image diffusion model of the image generative machine-learning system are infused along with corresponding cross-attention features of a text-to-music diffusion model decoder layers using a fusion operation. The text-to-music diffusion model then projects a spectrogram representation of the digital music into a latent space. A music decoder of the audio generative machine-learning system generates spectrograms from the spectrogram representation, which is used to generate waveform data using a waveform generator module (e.g., a vocoder) as the digital music in this example.

In this way, multimodal digital audio generation expands beyond conventional single modal approaches through joint conditioning of one or more machine-learning models. Multimodal implementation enables the machine-learning models to capture an underlying essence of mood, setting, and environment with increased detail that expresses tone and nature as part of the digital music and other types of digital audio. Further discussion of these and other examples is included in the following sections and shown in corresponding figures.

In the following discussion, an example environment is described that employs the multimodal digital audio generation techniques described herein. Example procedures are also described that are performable in the example environment as well as other environments. Consequently, performance of the example procedures is not limited to the example environment and the example environment is not limited to performance of the example procedures.

### Example Multimodal Digital Audio Generation Environment

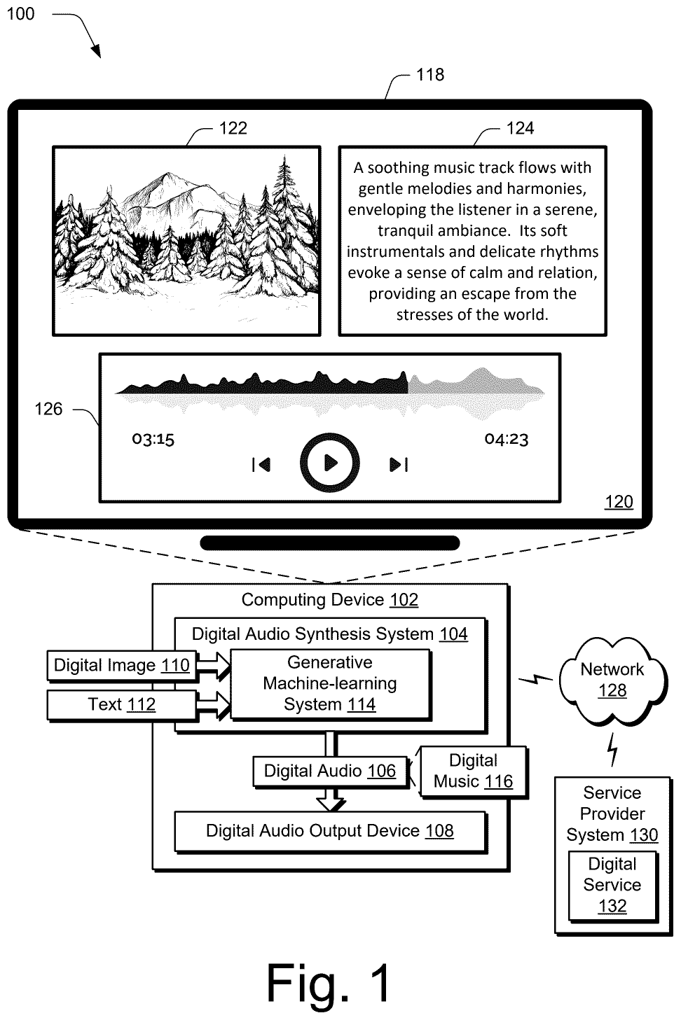

FIG. 1 is an illustration of a digital medium environment 100 in an example implementation that is operable to employ multimodal digital audio generation techniques described herein. The illustrated environment 100 includes a computing device 102, which is configurable in a variety of ways.

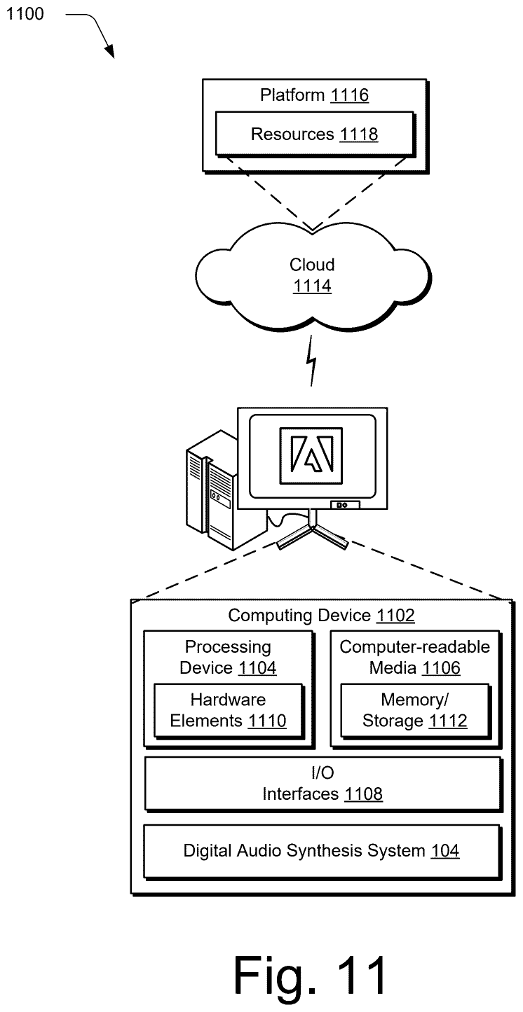

The computing device 102, for instance, is configurable as a desktop computer, a laptop computer, a mobile device (e.g., assuming a handheld configuration such as a tablet or mobile phone), and so forth. Thus, the computing device 102 ranges from full resource devices with substantial memory and processor resources (e.g., personal computers, game consoles) to a low-resource device with limited memory and/or processing resources (e.g., mobile devices). Additionally, although a single computing device 102 is shown, the computing device 102 is also representative of a plurality of different devices, such as multiple servers utilized by a business to perform operations “over the cloud” as described in FIG. 11.

The computing device 102 is illustrated as including a digital audio synthesis system 104. The digital audio synthesis system 104 is implemented at least partially in hardware of the computing device 102 (e.g., through use of a processing device and computer-readable storage medium) to generate digital audio 106. The digital audio 106 is illustrated as output by the digital audio synthesis system 104 for rendering by a digital audio output device 108, e.g., through use of a digital/analog converter (DAC), amplifier, and speakers.

The digital audio synthesis system 104 is configured to generate the digital audio 106 based on multimodal inputs, e.g., using a digital image 110, a text 112 input, and so on. Other examples of modal inputs are also contemplated, such as auditory inputs, tactile inputs, motion and spatial inputs (e.g., through use of a game controller, shuffle controller on a music mixer), and so forth.

The digital audio synthesis system 104 employs a generative machine-learning system 114 to generate the digital audio 106 (e.g., as digital music 116) in this example. The generative machine-learning system 114 is configured to employ artificial intelligence through one or more machine-learning models that are trained and retrained to generate new data instances based on a given dataset. The generative machine-learning system 114, for instance, is trained using digital images, text, and digital audio to then generate instances of digital audio 106 based on subsequent inputs of text and digital images.

Digital music 116 is found in a wide range of usage scenarios, examples of which include use to set a mood for an accompanying still image, animation, digital video, text descriptions as part of a social media post, and so on. However, finding the “correct” digital music for use in a particular scenario is cumbersome in conventional techniques. Conventional techniques, for instance, typically rely on repeated searches of a repository to locate a particular track of digital music that is appropriate to a particular context through a process of trial-and-error that relies on specialized knowledge of the user.

Although conventional techniques have been developed to generate digital audio using machine learning, these techniques are single modal and employ text, solely. Therefore, in order to generate digital audio to accompany a digital image using conventional techniques, a tedious effort is typically undertaken as part of interaction with conventional techniques to produce long, descriptive captions that are sensitive to specific attributes to capture an essence of a digital image. Further, this effort in conventional techniques is dependent on the correct use of particular terms that correspond to how a particular machine-learning model is trained to achieve different outcomes. As such, conventional techniques also encounter scalability issues (e.g., for social media content creators) and therefore do not support use in a digital service scenario involving multitudes of users.

As previously mentioned, digital music 116 differs from generic digital audio 106 in that digital music 116 involves an arrangement of elements that are structured to form a coherent and complete entity. Examples of these elements include melody, harmony, rhythm, dynamics, and form. Also, unlike generic digital audio (e.g., ambient sounds), digital music 116 often includes harmonies from different instruments that form intricate and layered structures. Generation of digital music 116 also involves additional technical challenges in that human hearing is extremely sensitive to audio artifacts when included in digital music 116, e.g., disharmony. As a result, techniques used to generate digital music 116 have a reduced margin of error when compared with techniques used to construct generic audio tracks. Accordingly, generation of digital music 116 is tasked with addressing fine-grained nuances of a composition involving melody, interplay of different instruments, and genre.

Multimodal techniques described herein are configured to address complexity encountered due to a multifaceted nature of music and abstract associations between auditory experiences and other sensory modalities. Integration of textual cues, for instance, involves an understanding of semantics and emotions within a given item of text. Digital image interpretation, on the other hand, involves spatial, color, and object recognition coupled with extrapolation of associated sentiments and narratives portrayed in the digital images. However, alignment of these insights to compose a coherent and emotionally resonant piece of digital music 116 introduces additional complexities not found in other generative techniques.

To address these technical challenges, the generative machine-learning system 114 is configured to leverage natural language of the text 112 as a cue to a nature of the digital music 116 to be generated as well as details of the compositions, e.g., in terms of instruments used, tempo, beat, and so forth. Visual cues detected from the digital image 110, on the other hand, capture semantical intricacies and provide increased efficiency in terms of capturing an underlying mood, which is difficult and inefficient to perform solely using text.

In the illustrated example of the display device 118 as displaying a user interface 120, a digital image 122 is selected that depicts a winter mountain scene. Text 124 is also input stating “A soothing music track flows with gentle melodies and harmonies, enveloping the listener in a serene, tranquil ambiance. Its soft instrumentals and delicate rhythms evoke a sense of calm and relation, providing an escape from the stresses of the world.” In response, the generative machine-learning system 114 generates digital music 126 depicted in the user interface 120 using a spectrogram and output as a waveform by the digital audio output device 108. Although illustrated as implemented locally at the computing device 102, functionality of the digital audio synthesis system 104 is also configurable as whole or part via functionality available via the network 128, such as by a service provider system 130 as part of a digital service 132 “in the cloud,” e.g., a social media service, content creation service, and so on.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Multimodal Digital Audio Generation

The following discussion describes multimodal digital audio generation techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks.

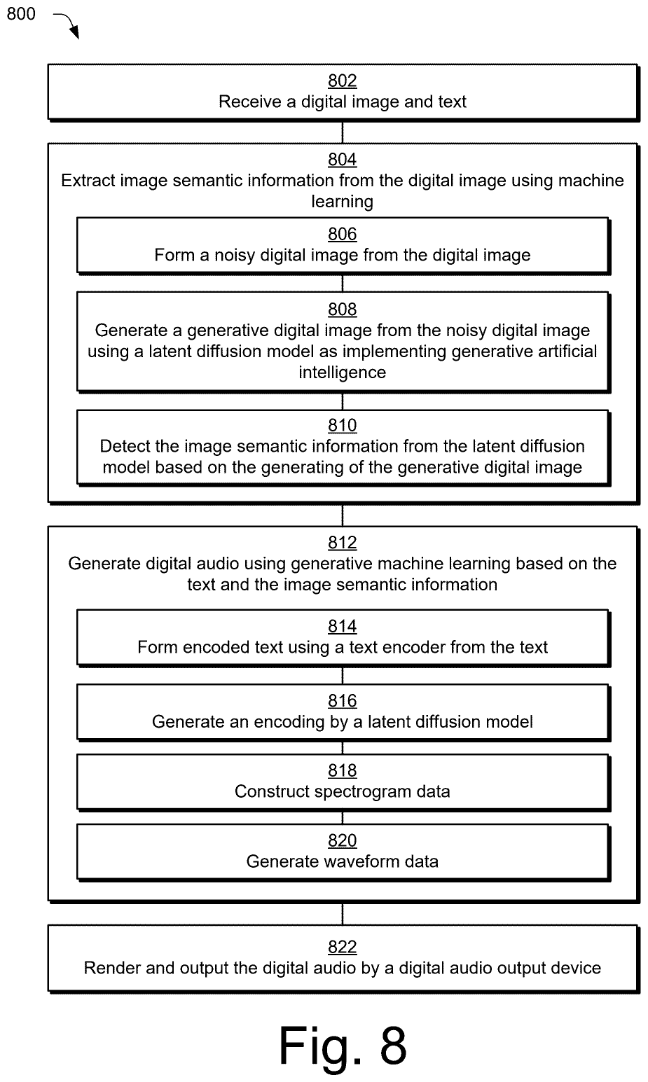

Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. FIG. 8 is a flow diagram depicting an algorithm 800 as a step-by-step procedure in an example implementation of operations performable for accomplishing a result of generating digital audio based on multimodal inputs. In portions of the following discussion, reference will be made to FIG. 8 in parallel with the following figures.

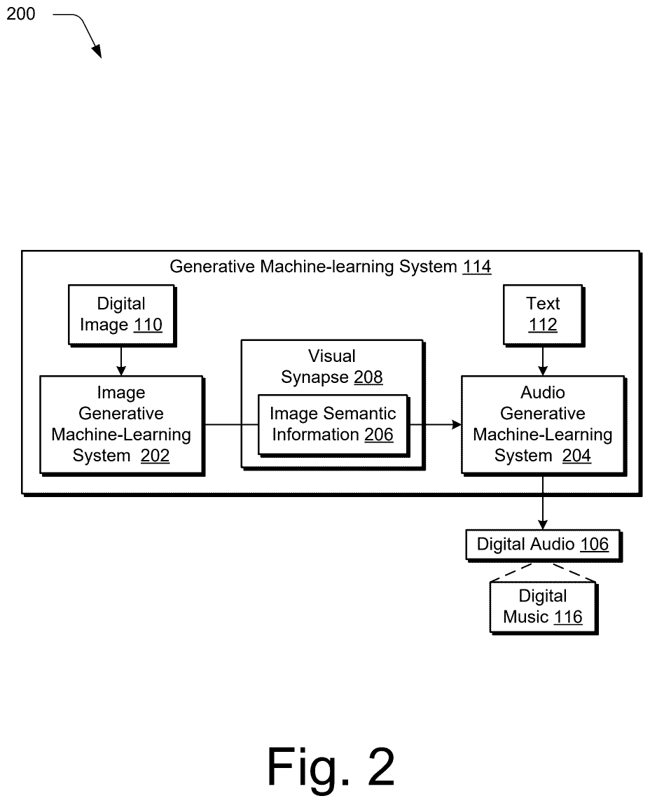

FIG. 2 depicts an implementation example 200 of operation of the generative machine-learning system 114 in greater detail as employing an image generative machine-learning system 202 and an audio generative machine-learning system 204 to generate digital audio 106. The generative machine-learning system 114 receives a digital image 110 and text 112 (block 802) as examples of multimodal inputs. The digital image 110 is passed to the image generative machine-learning system 202 and the text 112 is passed as an input to the audio generative machine-learning system 204.

Image semantic information 206 generated by the image generative machine-learning system 202 is used to guide generation of the digital audio 106 by the audio generative machine-learning system 204. To do so, the generative machine-learning system 114 incorporates a visual synapse 208 between the image generative machine-learning system 202 and the audio generative machine-learning system 204. The visual synapse 208 is configured to share one or more parameters of the image semantic information 206 to guide generation of the digital audio 106 by the audio generative machine-learning system 204 along with the text 112.

In the following discussion, the generative machine-learning system 114 is configured to learn a conditional distribution “M (w|I,Y),” that is usable to generate music waveforms “w” from a digital image 110 “I” and text 112 referred to in the following discussion as a paired textual description “Y.” The generative machine-learning system 114 materializes “M” as a diffusion model that is configured to interleave semantic cues from the digital image 110 and textual modality from the text 112 while generating the digital music 116.

To do so, the generative machine-learning system 114 is configured in this example to employ two subcomponents. The first subcomponent involves an approach to extract relevant visual information from digital image 110 by the image generative machine-learning system 202. The second subcomponent incorporates this conditioning as image semantic information 206 into the audio generative machine-learning system 204 in a parameter efficient way in order to generate the digital audio 106. Further discussion of implementation of these subcomponents is included below are described in relation to respective figures.

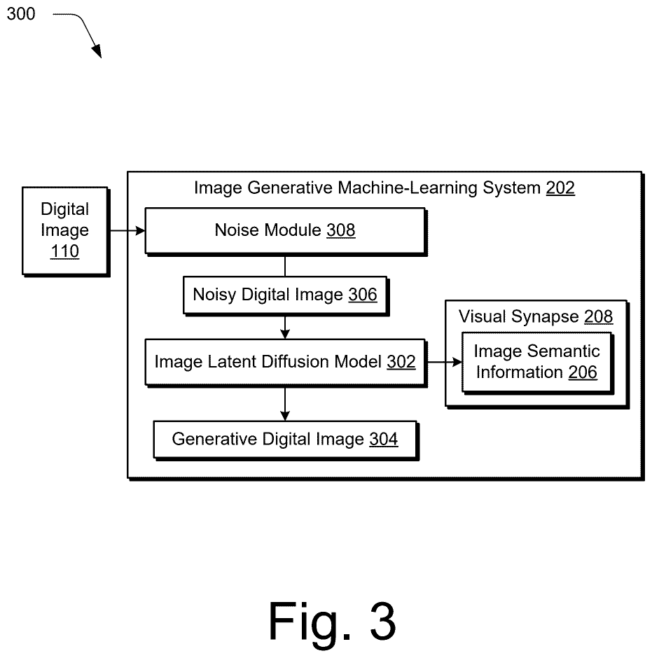

FIG. 3 depicts a system 300 in an example implementation showing operation of the image generative machine-learning system 202 of FIG. 2 in greater detail. The image generative machine-learning system 202 is configured to extract image semantic information 206 for the digital image using machine learning (block 804) as visual guidance from the digital image 110. To do so in the illustrated example, the image generative machine-learning system 202 employs an image latent diffusion model 302. The image latent diffusion model 302 is an example of a diffusion model configured to generate a generative digital image 304 using generative artificial intelligence based on an input.

The image latent diffusion model 302, for instance, is configurable as a text-to-image diffusion model. As previously described, diffusion models are a class of generative models that are trained by transforming a sample of noise into a structured output over successive iterations. Latent diffusion models apply the diffusion process in a latent space (e.g., to a compressed or abstract representation of the data) which increases operational efficiency during both training and subsequent use of the trained model through use of lower-dimensional data.

Accordingly, in this example the image latent diffusion model 302 as part of generating the generative digital image 304 forms latent representations and transformations. Theses latent representations and transformations encode image semantic information 206 as semantic knowledge usable as a guide to the audio generative machine-learning system 204 via the visual synapse 208. The image generative machine-learning system 202, for instance, is configurable as a stable diffusion model that is configured to encode a digital image into a latent space, a text encoder, and a convolutional neural network (CNN) for implementation of a diffusion process on the digital image in the latent space, e.g., a “UNet.” The convolutional neural network, for instance, includes an encoder, a bottleneck layer, and a decoder, with the encoder and decoder further containing a set of blocks with cross-attention layers, self-attentional layers, and convolutional layers.

Given an intermediate latent image feature “f∈R(w×h)×d”. “, a single self-attention operation of “Q=W^{k}f,” “K=W^{k}f,” “V=W^{v}f” is represented as follows:

$$Attention ( Q , K , V ) = Softmax ( QKT / √ dk ) V$$

where “dₖ” is the dimension of the query and key features. During cross-attention, the key and value matrices operate on the external text conditioning “c∈R^{s×dk}”: K=W^{k}c,” and “V=W^{v}c.” Here, “W^{q}”, “W^{k}”, and “W^{v}” are the attention weight matrices that transform either the image features or text conditions into the output of each block.

The image generative machine-learning system 202 is configured to transfer the image semantic information 206 that is present within these attention layers corresponding to the image “I” into the audio generative machine-learning system 204 through use of the visual synapse 208. To generate the image semantic information 206, a noise module 308 is utilized to form a noisy digital image 306 from the digital image 110 (block 806). The noise module 308, for instance, first inverts digital image 110 “I” into the latent space using DDIM Inversion to generate the noisy digital image 306 represented as “Z_{T}^{I}.” This inversion operation ensures that the image latent diffusion model 302 is able to generate the generative digital image 304 that matches the digital image 110 using the noisy digital image 306.

Next, a generative digital image 304 is generated from the noisy digital image 306 using an image latent diffusion model 302 as implementing generative artificial intelligence (block 808). Reverse diffusion steps, for instance, are performed using a pre-trained text-to-image LDM of the image latent diffusion model 302 starting from “Z_{T}^{I}.”

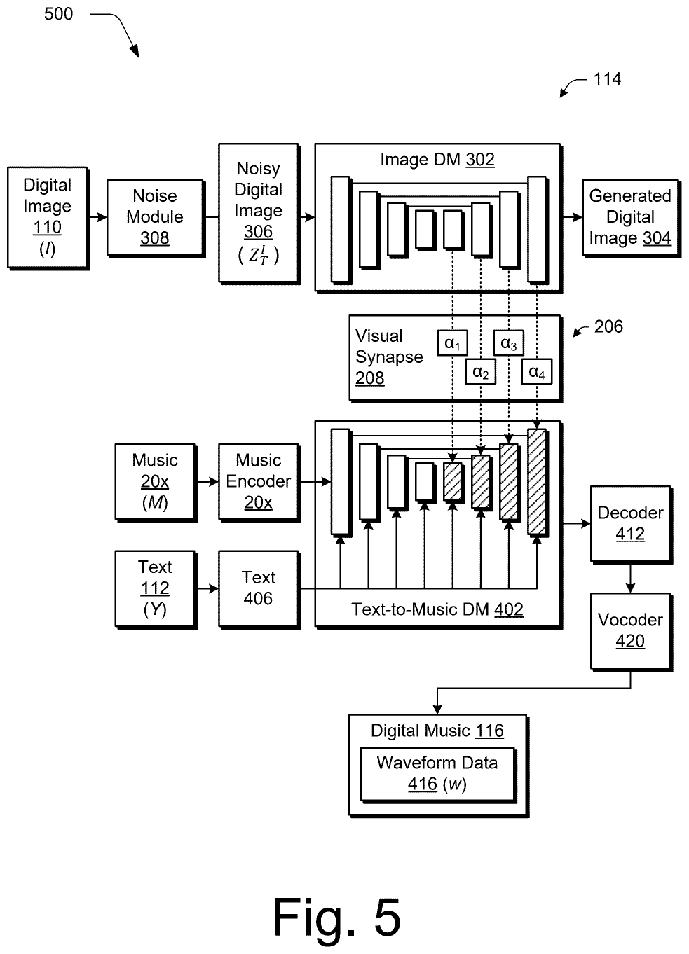

During the generation of the generative digital image 304, image semantic information 206 is detected as generated by the latent diffusion model (block 810). Self-attention features “K=W^{k}f,” “V=W^{v}f”, for instance, form the image semantic information 206 and are injected into the audio generative machine-learning system 204 via the visual synapse 208. The self-attention features control the feature transformations responsible for generating visual semantics of the image, as shown mathematically in the above equation. The following discussion includes additional elaboration on how the visual synapse 208 is constructed to transfer the image semantic information 206 as guidance information from the digital image 110 “I” to the audio generative machine-learning system 204 in relation to FIG. 5.

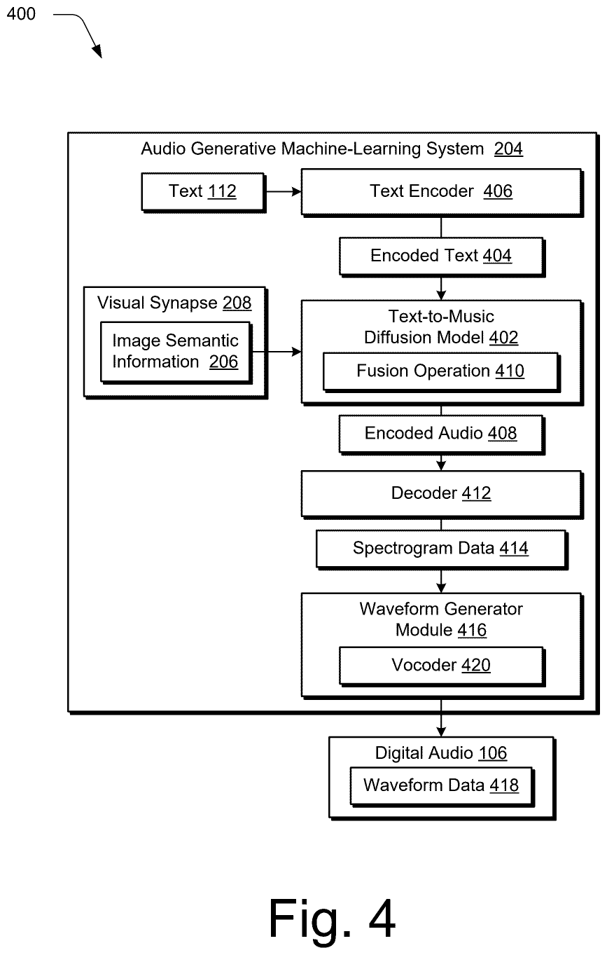

FIG. 4 depicts a system 400 showing operation of the audio generative machine-learning system 204 of FIG. 2 in greater detail as generating digital audio based on text and image semantic information 206 detected from the image generative machine-learning system 202 of FIG. 3. The audio generative machine-learning system 204 employs a text-to-music diffusion model 402 to generate digital audio using generative machine learning based on the text and the image semantic information (block 812).

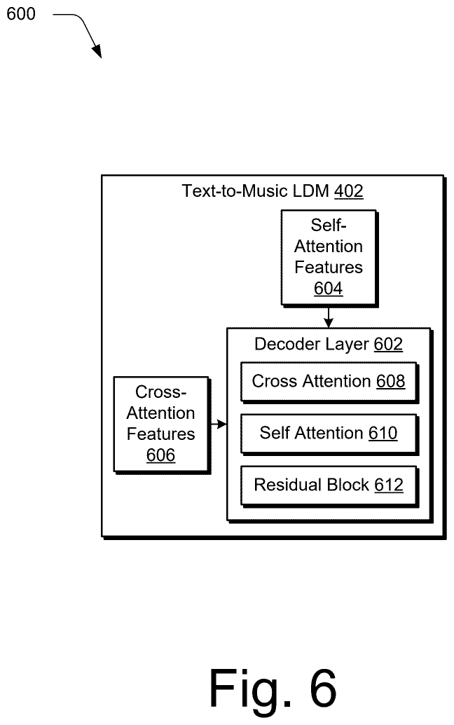

To do so, encoded text 404 is formed from the text 112 using a text encoder 406 (block 814). An encoding, illustrated as encoded audio 408, is generated by a latent diffusion model (block 816), e.g., the text-to-music diffusion model 402. To do so, the text-to-music diffusion model 402 employs a fusion operation 410 as further described below in relation to FIG. 6 to fuse the encoded text 404 with the image semantic information 206 to generate encoded audio 408. A decoder 412 is then employed to construct spectrogram data 414 from the encoded audio 408 (block 818). A waveform generation module 416 generates the digital audio 106 in this example as waveform data 418 based on the spectrogram data 414 (block 820) e.g., using a vocoder 420. The digital audio 106 is then output by the digital audio synthesis system 104 for rendering by a digital audio output device 108 (block 822), e.g., through use of a digital/analog converter (DAC), amplifier, and speakers.

FIG. 5 depicts a system 500 in an example implementation showing training of the generative machine-learning system 114 of FIGS. 2-4 in greater detail. During training, a music waveform “w” is first converted to a spectrogram “s∈R^{E×F}”, which is a visual representation obtained via Fourier Transformation on the music waveform “w.” Variables “E” and “F” denote a number of time slots and frequency slots, respectively. Spectrogram “s” is encoded into a latent representation “Z₁^{M}∈R^{C×E/r×F/r},” where “C” is a number of channels and “r” is a compression level. The forward diffusion process involves corrupting “Z₁^{M}” using a Markovian noise process “q,” which gradually adds noise to “Z₁^{M}” through “Z₁^{M}” over “T” steps with the following Gaussian function:

$$q ( {z}_{t}^{M} \vert {z}_{t - 1}^{M} ) = 𝒩 ( {z}_{t}^{M} ; \sqrt{1 - {β}_{t}} {z}_{t - 1}^{M} , {β}_{t} I )$$

where “βₜ” is a predetermined variance schedule. This iterative sampling process is approximated below by a deterministic non-Markovian process as follows:

$$\begin{matrix}q ( {z}_{t}^{M} \vert {z}_{1}^{M} ) = 𝒩 ( {z}_{t}^{M} ; \sqrt{{\overline{γ}}_{i}} {z}_{1}^{M} , ( 1 - {\overline{γ}}_{i} ) I ) \\ = \sqrt{{\overline{γ}}_{i}} {z}_{1}^{M} + ϵ \sqrt{( 1 - {\overline{γ}}_{t} ) ,} ϵ ∼ 𝒩 ( 0 , I )\end{matrix}$$

$$where$$

$${γ}_{t} = 1 - {β}_{t}$$

$$and$$

$${γ}_{t} = {\prod }_{r = 0}^{t} {γ}_{r}$$

In the reverse diffusion process, an LDM “ϵθ(·,·,·)” (e.g., implemented as a UNet), learns to denoise “Z₁^{M}˜N (0,1)” to recover “Z₁^{M}.” The architecture of the UNet may be configured similar to the image latent diffusion model 302 as described above. To incorporate image semantic information 206 (e.g., the additional guidance from image conditioning) the cross-attention key and value features “Kₗ^{M}” and “Vₗ^{M}” in each of the decoder layers of the UNet is modified as follows:

$$\begin{matrix}{K}_{i}^{M} = {α}_{l} {K}_{l}^{I} + ( 1 - {α}_{l} ) {K}_{l}^{M} \\ {V}_{i}^{M} = {α}_{l} {V}_{l}^{I} + ( 1 - {α}_{l} ) {V}_{l}^{M}\end{matrix} ,$$

where “Kₗ^{l}” and “Vₗ^{l}” are self-attention features for the corresponding layer “l” of the image latent diffusion model 302.

In the illustrated example, a convex combination between these features is modulated by learned layer specific “α” parameters via the visual synapse 208 as image semantic information 206. This formulation incorporates the image guidance from the image latent diffusion model 302 into the text-to-music diffusion model 402 without hampering expressivity of the model. As the “α” parameters facilitate the information exchange between the text-to-audio and text-to-image diffusion models, analogous to how a synapse in a nervous system facilitates the transfer of electrical and chemical signals between neurons, this handshake is referred to as the visual synapse 208 of a text-to-music diffusion model 402, e.g., LDM. Finally, the parameters of the text-to-music diffusion model 402 and the “α” parameters are trained end-to-end with the following loss function:

$$ℒ = {𝔼}_{t ∼ [ 1 , T ] , {z}_{1}^{M} , {ϵ}_{i}^{M} ∼ 𝒩 ( 0 , 1 )} {‖ {ϵ}_{t}^{M} - {ϵ}_{θ} ( {z}_{t}^{M} , c , t ) ‖}^{2}$$

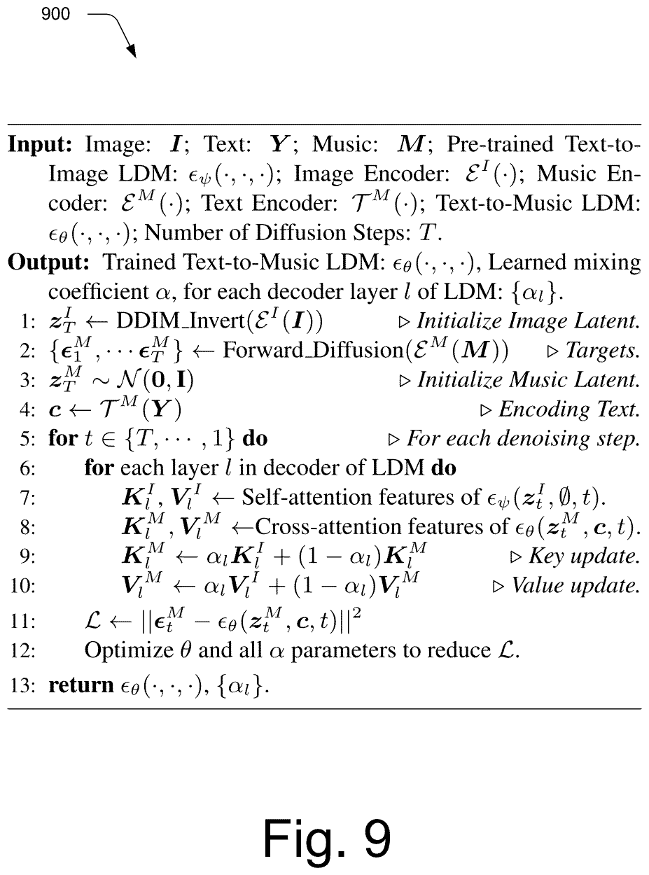

In this way, the generative machine-learning system 114 includes a visual synapse 208 that serves as a channel, through which, the text-to-music diffusion model 402 is guided by the image latent diffusion model 302 through image semantic information 206 contained in corresponding image conditioning. An example of operation of the visual synapse 208 is described in lines seven through ten of the algorithm 900 of FIG. 9 describing training of the generative machine-learning system 114.

FIG. 6 depicts a system 600 in an example implementation showing operation of a decoder layer 602 of the text-to-music diffusion model 402 of FIG. 5 in greater detail. The decoder layer 602 receives self-attention features 604 from a corresponding layer of the image latent diffusion model 302. The decoder layer 602 also receives cross-attention features 606 from an encoder layer of the text-to-music diffusion model 402. The decoder layer 602 includes a cross-attention 608 layer, a self-attention 610 layer, and a residual block 612.

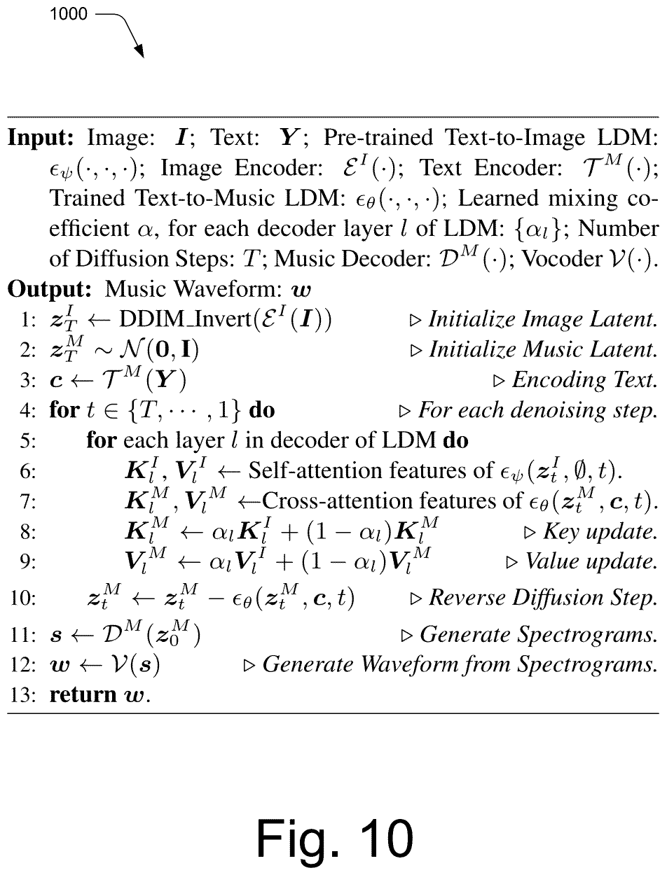

FIG. 10 depicts an algorithm 1000 describing operation of the generative machine-learning system 114 of FIGS. 2-4 to generate digital audio 106 as waveform data 418. The visual synapse 208, as previously described, is used to guide the text-to-music diffusion model 402 of the audio generative machine-learning system 204 toward semantic concepts contained in the image semantic information 206 received from the image latent diffusion model 302 of the image generative machine-learning system 202. The visual synapse 208 is detailed in lines seven through ten of the algorithm 1000. The rest of the algorithm 1000 follows an LDM training flow.

During inference, the trained image latent diffusion model 302 and the text-to-music diffusion model 402 are used along with the image semantic information 206 as the learned “α” parameters. As seen in lines eight and nine in the algorithm 1000, the cross-attention features of the text-to-music diffusion model 402 are updated to incorporate the visual conditioning in each denoising operation. Once denoising is completed at line ten, the latent representation is projected back into spectrogram data 414 using a decoder 412, and then the waveform data 418 is generated using a vocoder 420 of the waveform generation module 416 in lines eleven and twelve, respectively.

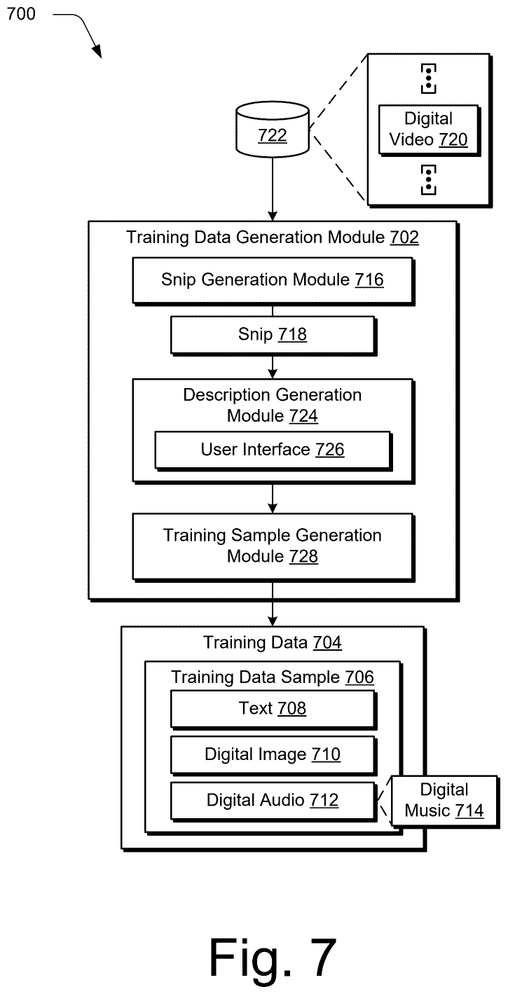

FIG. 7 depicts an example implementation 700 of generation of training data usable to train the generative machine-learning system 114 of FIG. 1. Conventional techniques do not support generation of training data that is usable to train the generative machine-learning system 114, e.g., as a “<Image, Text, Music>” tuple. Accordingly, implementation of a training data generation module 702 is described in this example that is configured to generate training data 704 having training data samples 706 of text 708, a digital image 710, and digital audio 712, e.g., digital music 714.

To do so, a snip generation module 716 is employed in the illustrated example to form a snip 718 from digital video 720, which is illustrated as stored in a repository 722. The snip, for instance, is configurable as a ten second snippet of the digital video 720 from the repository 722 (e.g., video sharing digital service) from a variety of genres, e.g., fifteen. Accordingly, each snip 718 includes the digital image 710 and digital audio (e.g., digital music 714) of the training data sample 706.

A description generation module 724 is then employed to generate the text 708 as a description of the digital image 710 and/or the digital audio 712. The description generation module 724, for instance, outputs a user interface 726 that is configured to receipt an input as a free-form text description expressing the composition, music-related details describing genre, mood tempo, singer voices, instrumentation, dissonances, rhythm, and so forth. A selected frame from the snip 718 by a training sample generation module 728 is used as the digital image 710 and music from the snip 718 along with the text description forms the “<Image, Text, Music>” tuple that is usable as described in relation to FIG. 5 to train the image diffusion model 302 and the text-to-music diffusion model 402 of the generative machine-learning system 114.

In order to evaluate efficacy of the generative machine-learning system 114, an image music similarity metric (IMSM) is also developed. A “CLIP” score is a metric usable for measuring the similarity between a digital image and a corresponding textual description. “N” pairs of images and texts are passed through respective encoders (pre-trained using CLIP loss) to obtain corresponding feature embeddings which are used to compute CLIP score matrix “A_{CLIP}∈R^{N×N}” Similarly, “CLAP” scores are computed amongst “N” audio-text pairs yielding a CLAP score matrix “A_{CLAP}∈R^{N×N}.” In both the matrices, the columns represent text modality in this example.

Accordingly, a metric “IMSM” is developed as a measure of perceptual similarity between given digital image/digital music pairs bridged by the text modality. In particular, CLIP image and text encoders are used which are contrastively aligned to compute the image and text feature embeddings. As a second step, language is leveraged as a bridging modality by freezing the CLIP text encoder and aligning the music (audio) encoder via contrastive training. Finally, for “ [symbol] Image, Text, Music [symbol] ” pairs, a value of the IMSM metric is obtained by combining ACLIP and ACLAP, e.g., using the given mathematical expression:

[symbol]

_{IMSM}= [symbol] _{CLIP}∈ [symbol] _{CLAP}^{T}

In this way, the efficacy of the generative machine-learning system 114 is evaluated, which is not possible in conventional techniques.

### Example System and Device

FIG. 11 illustrates an example system generally at 1100 that includes an example computing device 1102 that is representative of one or more computing systems and/or devices that implement the various techniques described herein. This is illustrated through inclusion of the digital audio synthesis system 104. The computing device 1102 is configurable, for example, as a server of a service provider, a device associated with a client (e.g., a client device), an on-chip system, and/or any other suitable computing device or computing system.

The example computing device 1102 as illustrated includes a processing device 1104, one or more computer-readable media 1106, and one or more I/O interface 1108 that are communicatively coupled, one to another. Although not shown, the computing device 1102 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 1104 is representative of functionality to perform one or more operations using hardware. Accordingly, the processing device 1104 is illustrated as including hardware element 1110 that is configurable as processors, functional blocks, and so forth. This includes implementation in hardware as an application specific integrated circuit or other logic device formed using one or more semiconductors. The hardware elements 1110 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1106 is illustrated as including memory/storage 1112 that stores instructions that are executable to cause the processing device 1104 to perform operations. The memory/storage 1112 represents memory/storage capacity associated with one or more computer-readable media. The memory/storage 1112 includes volatile media (such as random access memory (RAM)) and/or nonvolatile media (such as read only memory (ROM), Flash memory, optical disks, magnetic disks, and so forth). The memory/storage 1112 includes fixed media (e.g., RAM, ROM, a fixed hard drive, and so on) as well as removable media (e.g., Flash memory, a removable hard drive, an optical disc, and so forth). The computer-readable media 1106 is configurable in a variety of other ways as further described below.

Input/output interface(s) 1108 are representative of functionality to allow a user to enter commands and information to computing device 1102, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1102 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1102. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1102, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1110 and computer-readable media 1106 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1110. The computing device 1102 is configured to implement particular instructions and/or functions corresponding to the software and/or hardware modules. Accordingly, implementation of a module that is executable by the computing device 1102 as software is achieved at least partially in hardware, e.g., through use of computer-readable storage media and/or hardware elements 1110 of the processing device 1104. The instructions and/or functions are executable/operable by one or more articles of manufacture (for example, one or more computing devices 1102 and/or processing devices 1104) to implement techniques, modules, and examples described herein.

The techniques described herein are supported by various configurations of the computing device 1102 and are not limited to the specific examples of the techniques described herein. This functionality is also implementable all or in part through use of a distributed system, such as over a “cloud” 1114 via a platform 1116 as described below.

The cloud 1114 includes and/or is representative of a platform 1116 for resources 1118. The platform 1116 abstracts underlying functionality of hardware (e.g., servers) and software resources of the cloud 1114. The resources 1118 include applications and/or data that can be utilized while computer processing is executed on servers that are remote from the computing device 1102. Resources 1118 can also include services provided over the Internet and/or through a subscriber network, such as a cellular or Wi-Fi network.

The platform 1116 abstracts resources and functions to connect the computing device 1102 with other computing devices. The platform 1116 also serves to abstract scaling of resources to provide a corresponding level of scale to encountered demand for the resources 1118 that are implemented via the platform 1116. Accordingly, in an interconnected device embodiment, implementation of functionality described herein is distributable throughout the system 1100. For example, the functionality is implementable in part on the computing device 1102 as well as via the platform 1116 that abstracts the functionality of the cloud 1114.

In implementations, the platform 1116 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving, by a processing device, a digital image and text;
extracting, by the processing device, image semantic information from the digital image using machine learning;
generating, by the processing device, digital audio using generative machine learning based on the text and the image semantic information extracted from the digital image; and
outputting, by the processing device, the digital audio.

2. The method as described in claim 1, wherein the digital audio is digital music.

3. The method as described in claim 1, wherein the extracting of the image semantic information is performed using a first diffusion model.

4. The method as described in claim 3, wherein the generating of the digital audio is performed using a second diffusion model.

5. The method as described in claim 4, wherein the image semantic information is generated by respective layers of the first diffusion model and injected into corresponding layers of the second diffusion model.

6. The method as described in claim 4, wherein the generating of the digital audio is performed by the second diffusion model based on features extracted from the text and the image semantic information as injected into the second diffusion model from the first diffusion model.

7. The method as described in claim 1, wherein the extracting includes:
forming a noisy digital image from the digital image;
generating a generative digital image from the noisy digital image using a diffusion model as implementing generative artificial intelligence; and
detecting the image semantic information from the diffusion model based on the generating of the generative digital image by the diffusion model.

8. The method as described in claim 7, wherein:
the image semantic information is configured as self-attention features;
the generating of the digital audio is performed using a text-to-music diffusion model; and
the self-attention features are injected into the text-to-music diffusion model for use with cross-attention features extracted by the text-to-music diffusion model from the text as part of the generating the digital audio.

9. The method as described in claim 1, wherein the generating of the digital audio includes:
forming encoded text using a text encoder from the text using machine learning;
generating an encoding by a diffusion model based on the image semantic information and the encoded text;
constructing spectrogram data by a decoder using machine learning; and
generating the digital audio as waveform data based on the spectrogram data.

10. The method as described in claim 9, wherein the diffusion model employs a fusion operation using the encoded text and the image semantic information.

11. A system comprising:
a processing device; and
a computer-readable storage medium storing instructions that, responsive to execution by the processing device, causes the processing device to perform operations including:
generating training data, the generating including:
extracting a clip from a digital video, the clip including a digital image and digital audio;
receiving an input having text describing the clip; and
forming a training data sample including the digital image, the digital audio, and the clip; and
training a machine-learning model using the training data to generate subsequent digital audio based on an input digital image and input text.

12. The system as described in claim 11, wherein the input is received via a user interface that is configured to present the digital image and the digital audio.

13. The system as described in claim 11, wherein the receiving the input is performed using a caption generation machine-learning model that is configured to generate the text as a caption based on the digital image, automatically and without user intervention.

14. The system as described in claim 11, further comprising generating the subsequent digital audio based on the input digital image and input text.

15. One or more computer-readable storage media storing instructions that, responsive to execution by a processing device, causes the processing device to perform operations comprising:
extracting image semantic information from a digital image, the image semantic information generated using a first diffusion model; and
generating digital music using a second diffusion model based on text and the image semantic information extracted from the digital image.

16. The one or more computer-readable storage as described in claim 15, wherein the image semantic information is generated by respective layers of the first diffusion model and injected into corresponding layers of the second diffusion model.

17. The one or more computer-readable storage as described in claim 15, wherein the generating of the digital music is performed by the second diffusion model based on self-attention features extracted from the text and the image semantic information as injected into the second diffusion model from the first diffusion model.

18. The one or more computer-readable storage as described in claim 15, wherein the extracting includes:
forming a noisy digital image from the digital image;
generating a generative digital image from the noisy digital image using the first diffusion model as implementing generative artificial intelligence; and
detecting the image semantic information from the first diffusion model based on the generating of the generative digital image by the first diffusion model.

19. The one or more computer-readable storage as described in claim 15, wherein the generating of the digital music includes:
forming encoded text using a text encoder from the text using machine learning;
generating encoded music by the second diffusion model based on the image semantic information and the encoded text;
constructing spectrogram data by a decoder using machine learning; and
generating the digital music as waveform data based on the spectrogram data.

20. The one or more computer-readable storage as described in claim 19, wherein the second diffusion model employs a fusion operation using the encoded text and the image semantic information.
